(19) United States
(12) Patent Application Publication
(10) Pub. No.: US 2010/0185679 A1
(43) Pub. Date: Jul. 22, 2010

(54) System for Discovering Level of Support of Optional Features in a Database

(75) Inventors: Axel FERRAZZINI, Toronto (CA); Nicholas P. ALFANO, Stratford-Upon-Avon (GB); James Andrew GODFREY, Waterloo (CA)

Correspondence Address: Research in Motion Corp./CR;Attn: J. Robert Brown, 5601 Granite Parkway, Suite 750, Plano, TX, 75024, US

(73) Assignee: RESEARCH IN MOTION LIMITED, Waterloo (CA)

(21) Appl. No.: 12/353,778

(22) Filed: Jan. 14, 2009

(51) Int. Cl. G06F 7/00

(52) U.S. Cl. 707/791; 707/E17.055; 707/E17.044; 707/797

(57) ABSTRACT

A device is disclosed. The device comprises a storage device storing a data structure of features supported by the device. The data structure is created either dynamically or on command using an OpenMobileAlliance Device Management protocol.

### BACKGROUND

The Open Mobile Alliance (OMA) Device Management (DM) specification supports extensions called Management Objects (MOs), which are logical collections of related pieces of data stored in a virtual DM tree. A device that supports OMA DM typically has an embedded OMA DM client that acts as an intermediary between MOs and the applications, functions, agents, or other software or firmware components on the device that might make use of the MOs to configure their services. Any such component whether on the device or elsewhere will be referred to herein as an agent. An entity that interacts with the OMA DM client and an OMA DM server includes a Management Authority (MA) which may be a user, a network operator, a handset manufacturer, an enterprise administrator, an agent, or an application that may create, modify, or delete an MO, and may make requests to the device.

Each MO on a device typically contains data related to a specific agent application or capability of the device. For example, an email MO might contain data associated with an email agent. If multiple email agents are installed on a device, each might use a separate email MO, or they might all use the same email MO. All of the MOs and agents on a device typically interact via a single DM client. The device management (DM) tree organizes the MOs in a logical hierarchical manner. Each of these MOs might include multiple nodes that include a single integer value, an indicator, a flag, a universal resource identifier (URI), or might include, for example, a picture and/or other information.

An MO registry is maintained as a repository for values used for MO descriptions. The labels used in the MO registry can refer to assignments of values to MOs defined by OMA work groups, assignments of values to MOs defined by external entities, and/or values that are used for testing or private use. A copy of the MO description can be linked to each registered MO.

As used herein, the term “device” might, in some cases, refer to mobile devices such as mobile telephones, personal digital assistants, handheld or laptop computers, and similar devices that have telecommunications capabilities. In other cases, the term “device” might refer to devices that have similar capabilities but that are not transportable, such as fixed line telephones, desktop computers, set-top boxes, or network nodes. The term “device” can also refer to any hardware or software component that can terminate a communication session.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of a system for providing supported features of a device according to an embodiment of the disclosure.

FIG. 2 is a diagram of an example of a supported feature management object according to an embodiment of the disclosure.

FIG. 3a is a flow diagram of a method of maintaining supported services according to an embodiment of the disclosure.

FIG. 3b is a flow diagram of a method of maintaining a data structure of supported services according to an embodiment of the disclosure.

FIG. 4 is a diagram of a wireless communications system including a device operable for some of the various embodiments of the disclosure.

FIG. 5 is a block diagram of a device operable for some of the various embodiments of the disclosure.

FIG. 6 is a diagram of a software environment that may be implemented on a device operable for some of the various embodiments of the disclosure.

FIG. 7 is an illustrative computing system suitable for some of the various embodiments of the disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It may be useful for a service provider as well as others to have knowledge of supported features of a device. In the Open Mobile Alliance (OMA) Device Management (DM) protocol environment, a DM tree is provided that includes MOs associated with a particular service or feature. The MOs contain details about the specific service. However, the DM tree does not contain a centralized location of all services and features supported by a device. Accordingly, when information about an OMA DM supported feature of the device is desired, a device management (DM) server sends multiple commands to a DM client on the device to discover which MOs are supported by the DM tree, and the DM server recreates the DM tree locally. Once the DM tree is recreated, the DM server manually searches the entire DM tree to determine whether a particular service is supported. The manual search through the DM tree can be arduous and time consuming, and recreating the entire DM tree consumes resources. Also, during the manual search it is possible for the DM server to overlook or not discover the presence of a new feature on the device because of the way that the DM tree is organized. That is, if the DM server does not know where to look for a particular service or object, the DM server might not find the new feature.

Accordingly, in an embodiment, an MO, for example, a device Supported Feature Management Object (SupFeatMO), is provided that includes the features that are supported by the device. The SupFeatMO is or includes a data structure that, in some instances, might be a list of the features and services supported by the device. In other instances, the SupFeatMO might include a sub-tree or branch of the DM tree that includes various MOs related to supported features of the device. In other instances, the SupFeatMO might be an array, a file, or some other type of data structure. The MOs in the sub-tree might include links or representations of other MOs in the DM tree related to supported features of the device. The SupFeatMO may be dynamically updated when the DM tree is modified to provide concise and easily accessible knowledge of features of the device. Also, when a change occurs to an MO of the DM tree, the time and date of the change may be recorded along with the supported feature in the SupFeatMO. In this manner, auditing or tracking of supported features in the DM tree may be organized in the SupFeatMO rather than in the server or other systems. Providing a central location or data structure of supported features also eliminates or reduces the need to search the entire DM tree each time the DM server makes a request querying for OMA DM supported features on the device.

In another embodiment, an agent on the device organizes or manages the supported feature information to the SupFeatMO. In some instances, the agent might actively monitor transactions related to the DM tree, and as new features are added, the agent updates the SupFeatMO with the new features of the device. When the agent observes a change in the DM tree, the SupFeatMO may be updated in real time, or otherwise by the agent, to reflect the current state of supported features of the device. In other instances, the agent might periodically scan and extract supported feature information from the DM tree and compile the features into the SupFeatMO.

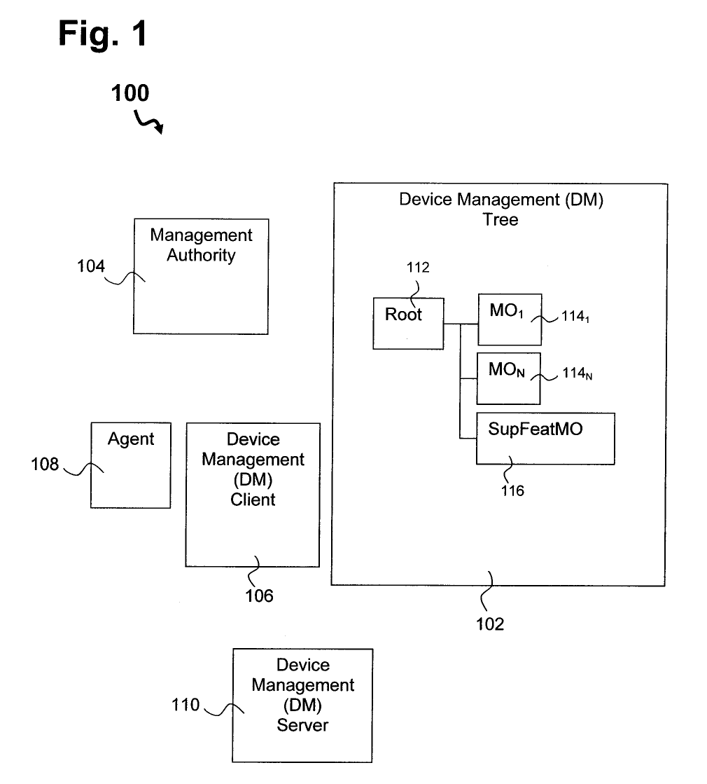

FIG. 1 is a block diagram of an embodiment of a system 100 for providing supported features of a device that includes one or more management authorities (MA) 104, a device management (DM) tree 102, a DM client 106, an agent 108, and a DM server 110. In an embodiment, some of these entities may not be present or may be combined in various combinations with one another or with other entities not shown. In some embodiments, the DM client 106 and the agent 108 might be co-located in a single physical entity or in more than one physical entity. When the DM server 110 sends a query for supported feature information to the DM client 106, the supported feature information may be provided by the DM client 106 to the DM server 110 with information from the DM tree 102.

The DM tree 102 includes one or more management object (MOs) 114₁ to 114_{N} organized in a hierarchical manner or other well known manner about a root object 112. The MOs 114₁ to 114_{N} might represent information used by an application on the device. For example, the MO 114₁ might be an email MO associated with an email application. The MO 114_{N} may include a web browser MO, a firmware MO, or other device-related MO. In some instances, each of the MOs 114₁ to 114_{N} may have an identifier and one or more nodes with MOs including OMA DM device-supported features. For example, the MO 114₁ may be an email MO having MO supported features such as POP version 3 or 4, Internet Message Access Protocol (IMAP), Internet Assigned Numbers Authority (IANA), and other features and protocols.

A Supported Feature Management Object (SupFeatMO) 116 may be located under the root object 112, or elsewhere in the DM tree 102, or separate from the DM Tree 102, and may store information related to one or more supported feature(s) on the device. The SupFeatMO 116 might store the supported feature information of the device in a condensed accessible format. The SupFeatMO 116 may list the supported feature(s) of the device as a text file, as an extensible markup language (XML) file that provides the supported feature information to a web browser, as a list of directory paths, as graphical representations, in other forms that might be accessible by the DM server 110, or in other manners that will suggest themselves to one skilled in the art. In an embodiment, the SupFeatMO 116 might include a list of, for example, URIs/URLs that provide links to supported feature(s) of the device. In an embodiment, the SupFeatMO 116 might include one or more unsupported features of the device. The following is an example of information that might be included in the SupFeatMO 116. It should be understood that this is only an example and that other syntax could be used to achieve a similar result.

```
<feature>
    <current state>
        <modifying MA>
            <date-time>
    <previous state>
        <modifying MA>
            <date-time>
\<feature>
```

In the above example, the <feature> might represent in-going or out-going Simple Mail Transport Protocol (SMTP) addresses. The <current state> and <previous state> might represent a current or previous state of one of the MOs 114₁ to 114_{N} of the DM tree 102. The <modifying MA> and the <date-time> represent the MA that modified the feature and the date and time of the modification.

The agent 108 might include an application that is configured for monitoring OMA DM protocol transactions. As the DM client 106 or other systems update or interact with the DM tree 102, the agent 108 may monitor, detect or otherwise determine if new features or capabilities have been added. In some instances, the agent 108 might add, modify or delete an entry wholly or partially in the SupFeatMO 116, such as an XML entry or a directory path. During installation of a new service or upon initial creation of the DM tree 102, the agent 108 may monitor transactions on the DM tree 102 and record or update the SupFeatMo 116 as the MOs 114₁ to 114_{N} are updated relative to supported and/or unsupported features of the device.

Various techniques might be used to observe changes in the DM tree 102. For example, in an embodiment, the agent 108 might eavesdrop on OMA DM protocol transactions involving the DM tree 102 by entities such as the DM client 106 or the DM server 110. When an OMA DM protocol transaction occurs regarding one or more of the MOs 114₁ to 114_{N} or the structure of the DM tree 102, the agent 108 updates the SupFeatMO 116 if a supported feature of the device was added, deleted, or modified.

In some embodiments, the agent 108 might periodically traverse the DM tree 102 in search of updated MOs. For example, the agent 108 might traverse the DM tree 102 daily or at other times that might be set forth by, for example, the DM server 110. In another embodiment, the MA 104, a user, or other application might also monitor the DM tree 102, and, in the event of a change in the structure of one of the MOs 114₁ to 114_{N} related to a supported feature of the device, might modify or otherwise promote the agent 108 updating the SupFeatMO 116 with the updated MO information.

In other embodiments, the agent 108 might monitor the memory size of the DM tree 102. When a change occurs in the memory size, the agent 108 scans the DM tree 102 to determine where a change occurred in the DM tree 102. Determining a change in the memory size might involve using, for example, a Java-based listener application that monitors the DM tree 102 for changes in memory block sizes of the MOs 114₁ to 114_{N}. When the listener application identifies a memory block change, a trigger in the root object 112 or elsewhere might invoke the agent 108 to scan the DM tree 102 to look for changes in any one of the MOs 114₁ to 114_{N}. Alternatively, the listener application might identify the change in the memory block, determine the location of the change in the DM tree 102, and subsequently notify the agent 108 of the portion of the DM tree 102 that changed. In other embodiments, other well known techniques for monitoring and responding to changes in a system, file, or structure such as the DM tree 102 may be used.

The agent 108 may also be used to selectively extract device-supported feature-related information from the DM tree 102. Thus, rather than providing and manually traversing the DM tree 102 each time the DM server 110 desires supported feature information of a device, the agent 108 may promote providing a list, summary, or other details of device-supported feature information to a requester such as the DM server 110. In some embodiments, the agent 108 may query and provide specific device support information. In still other embodiments, the agent 108 merely promotes maintaining or updating the SupFeatMO 116, and the requestor, such as the DM server 110, is provided the SupFeatMO 116 to query or analyze as desired.

The DM server 110 might include one or more centralized systems for handling and storing information and requests related to OMA DM. The DM server 110 also provides maintenance and service support to the DM client 106. For example, when a new service, application, or feature is to be loaded onto the device, the DM server 110 may need to determine the management objects supported by the DM client 106.

Requests for supported feature information from the DM server 110 may be handled by the DM client 106 or the DM agent 108. The DM client 106 might be any component capable of managing or evaluating the DM tree 102. In an embodiment, the DM client 106 might reside on a mobile device, and in other embodiments might reside elsewhere. In some instances, the DM client 106 may obtain and send the SupFeatMO 116 to the MA 104 via the DM server 110. As previously discussed, the DM client 106 and/or the DM agent 108, or combinations thereof, might provide the SupFeatMO 116 directly or might compile the supported features information from the SupFeatMO 116 into a format useable by the DM server 110 or other requesting entity.

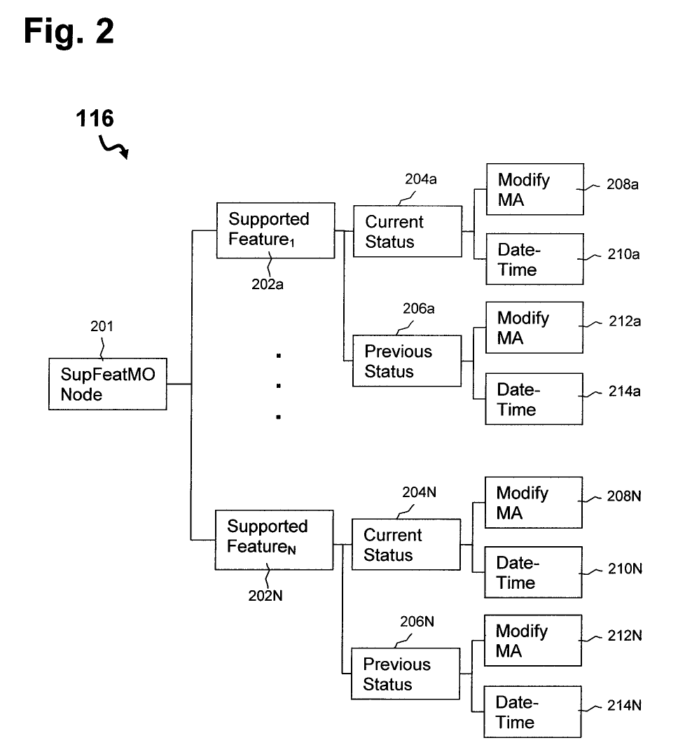

FIG. 2 is a block diagram of an embodiment of the SupFeatMO 116. In this example, one or more supported features 202a to 202_{N} are presented under a SupFeatMO Node 201. In an embodiment, the supported feature(s) 202a to 202_{N} might include management objects that include a current status 204a to 204_{N} and a previous status 206a to 206_{N}. The current status 204a to 204_{N} includes a Modify MA 208a to 208_{N} that may define a MA that recently modified one of the supported feature(s) 202a to 202_{N}, and a Date-Time 210a to 210_{N} that provides information regarding when the modification occurred. The previous status 206a to 206_{N} includes a Modify MA 212a to 212_{N} that defines a MA that previously modified supported feature(s) 202a to 202_{N}, and a Date-Time 214a to 214_{N} that denotes when the prior modification occurred.

The supported feature(s) 202a to 202_{N} might represent or include MOs of the DM tree 102 that are related to supported features of the device. For example, the supported feature(s) 202a to 202_{N} might include a supported feature MO of an email MO, a web browser MO, or an address book MO from the DM tree 102. The supported feature(s) 202a to 202_{N} might each represent a protocol that an email MO or web browser MO such as POP version 3 or 4, IMAP, IANA, or other OMA DM protocols or device security supported features, for example.

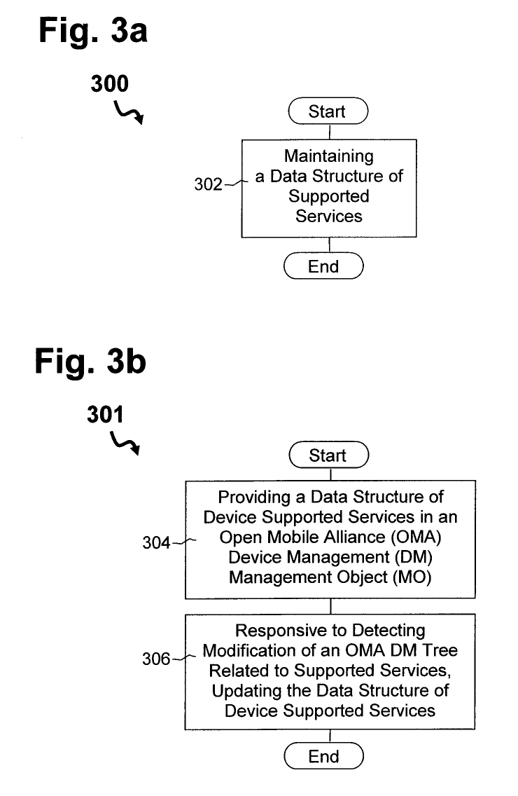

FIG. 3a illustrates a flow diagram of a method 300 of maintaining supported services. At block 302, the method provides for maintaining a data structure of supported services. In an embodiment, the data structure of supported services may be stored in a management object on an OMA DM tree. The data structure of supported services also includes one or more status and date information related to modification of each of the supported services.

FIG. 3b illustrates a flow diagram of a method 301 of maintaining a data structure of supported services. At block 304, the method includes providing a data structure of device supported services in an Open Mobile Alliance (OMA) Device Management (DM) Management Object (MO). At block 306, the method provides for updating the data structure of device supported services responsive to detecting modification of an OMA DM tree related to supported services.

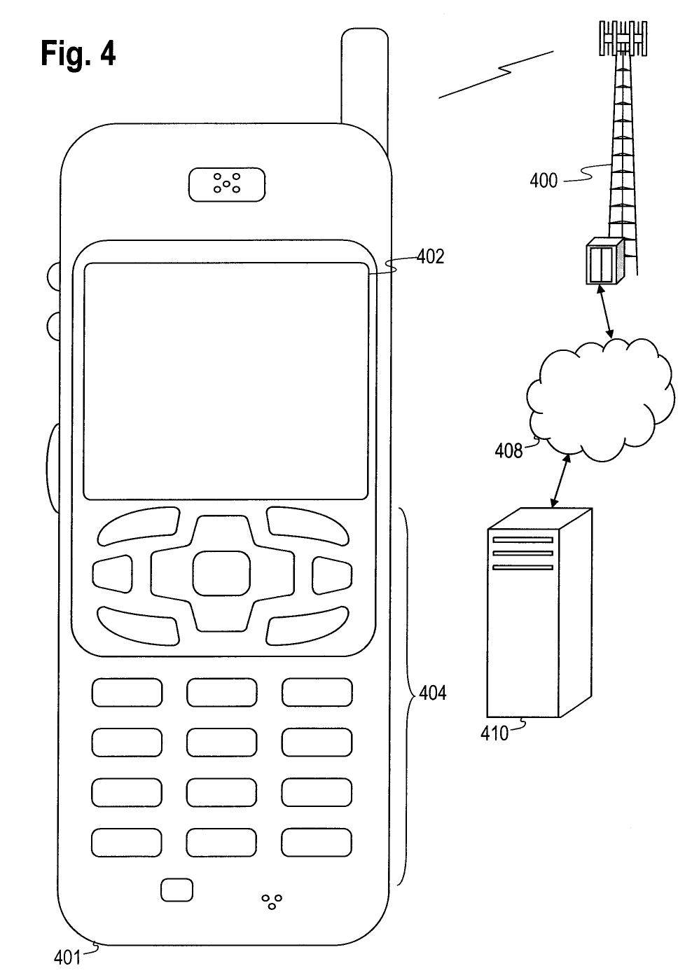

FIG. 4 illustrates a wireless communications system including an embodiment of a device 401. The device 401 is operable for implementing aspects of the disclosure, but the disclosure should not be limited to these implementations. Though illustrated as a mobile phone, the device 401 may take various forms including a wireless handset, a pager, a personal digital assistant (PDA), a portable computer, a tablet computer, or a laptop computer. Many suitable devices combine some or all of these functions. In some embodiments of the disclosure, the device 401 is not a general purpose computing device like a portable, laptop or tablet computer, but rather is a special-purpose communications device such as a mobile phone, a wireless handset, a pager, a PDA, or a telecommunications device installed in a vehicle. In another embodiment, the device 401 may be a portable, laptop or other computing device. The device 401 may support specialized activities such as gaming, inventory control, job control, telemetry data collection, and/or task management functions, and so on.

The device 401 may include a display 402. The device 401 may also include a touch-sensitive surface, a keyboard or other input keys generally referred as 404 for input by a user. The keyboard may be a full or reduced alphanumeric keyboard such as QWERTY, Dvorak, AZERTY, and sequential types, or a traditional numeric keypad with alphabet letters associated with a telephone keypad. The input keys may include a trackwheel, an exit or escape key, a trackball, and other navigational or functional keys, which may be inwardly depressed to provide further input function. The device 401 may present options for the user to select, controls for the user to actuate, and/or cursors or other indicators for the user to direct. The device 401 might also accept voice-based commands.

The device 401 may further accept data entry from the user, including numbers to dial or various parameter values for configuring the operation of the device 401. The device 401 may further execute one or more software or firmware applications in response to user commands. These applications may configure the device 401 to perform various customized functions in response to user interaction. Additionally, the device 401 may be programmed and/or configured over-the-air, for example, from a wireless base station, a wireless access point, or a peer device 401 and may have no external user input mechanisms/interfaces.

Among the various applications executable by the device 401 are a web browser, which enables the display 402 to show a web page. The web page may be obtained via wireless communications with a wireless network access node, a cell tower, a peer device 401, or any other wireless communication network or system 400. The network 400 is coupled to a wired network 408, such as the Internet. Via the wireless link and the wired network, the device 401 has access to information on various servers, such as a server 410. The server 410 may provide content that may be shown on the display 402. Alternately, the device 401 may access the network 400 through a peer device 401 acting as an intermediary, in a relay type or hop type of connection.

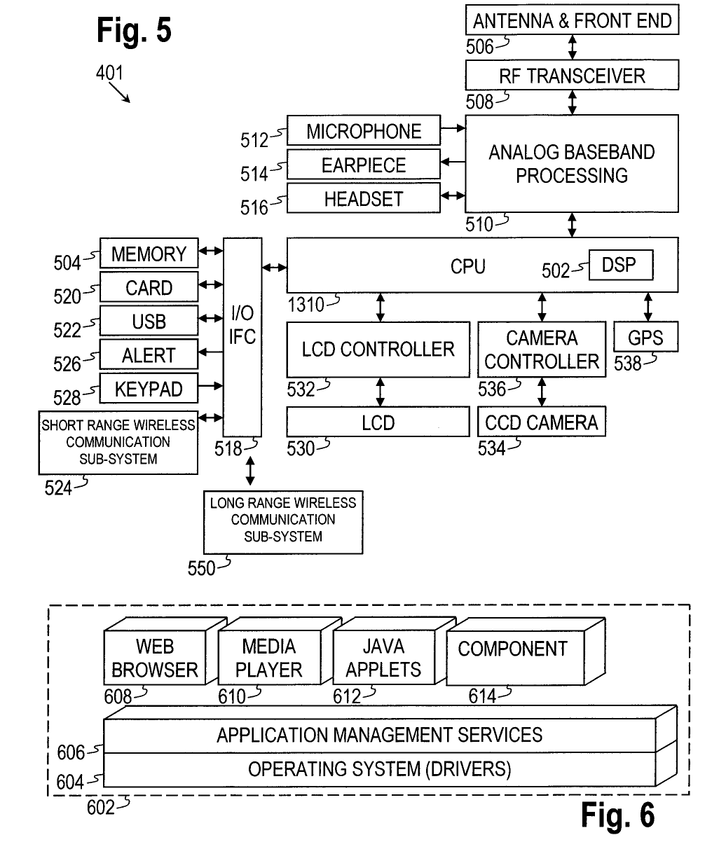

FIG. 5 shows a block diagram of the device 401. While a variety of known components of devices 401 are depicted, in an embodiment a subset of the listed components and/or additional components not listed may be included in the device 401. The device 401 includes a memory 504 and a central processing unit (CPU) 1310 that may incorporate a digital signal processor (DSP) 502. As shown, the device 401 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, a short range wireless communication sub-system 524, an alert 526, a keypad 528, a liquid crystal display (LCD) 530, which may include a touch sensitive surface, an LCD controller 532, a charge-coupled device (CCD) camera 534, a camera controller 536, and a global positioning system (GPS) module 538. In an embodiment, the device 401 may include another kind of display that does not provide a touch sensitive screen. In an embodiment, the DSP 502 may communicate directly with the memory 504 without passing through the input/output interface 518.

The DSP 502 or some other form of controller or central processing unit operates to control the various components of the device 401 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the device 401 to send and receive information from a cellular network or some other available wireless communications network or from a peer device 401. In an embodiment, the antenna and front end unit 506 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 506 may include antenna tuning and/or impedance matching components, RF power amplifiers, and/or low noise amplifiers.

The RF transceiver 508 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 510 and/or the DSP 502 or other central processing unit. In some embodiments, the RF Transceiver 508, portions of the Antenna and Front End 506, and the analog baseband processing unit 510 may be combined in one or more processing units and/or application specific integrated circuits (ASICs).

The analog baseband processing unit 510 may provide various analog processing of inputs and outputs, for example analog processing of inputs from the microphone 512 and the headset 516 and outputs to the earpiece 514 and the headset 516. To that end, the analog baseband processing unit 510 may have ports for connecting to the built-in microphone 512 and the earpiece speaker 514 that enable the device 401 to be used as a cell phone. The analog baseband processing unit 410 may further include a port for connecting to a headset or other hands-free microphone and speaker configuration. The analog baseband processing unit 510 may provide digital-to-analog conversion in one signal direction and analog-to-digital conversion in the opposing signal direction. In some embodiments, at least some of the functionality of the analog baseband processing unit 510 may be provided by digital processing components, for example by the DSP 502 or by other central processing units.

The DSP 502 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 502 may perform modulation, coding, interleaving, and spreading, and for a receiver function the DSP 502 may perform despreading, deinterleaving, decoding, and demodulation. In another embodiment, for example in an orthogonal frequency division multiplex access (OFDMA) technology application, for the transmitter function the DSP 502 may perform modulation, coding, interleaving, inverse fast Fourier transforming, and cyclic prefix appending, and for a receiver function the DSP 502 may perform cyclic prefix removal, fast Fourier transforming, deinterleaving, decoding, and demodulation. In other wireless technology applications, yet other signal processing functions and combinations of signal processing functions may be performed by the DSP 502.

The DSP 502 may communicate with a wireless network via the analog baseband processing unit 510. In some embodiments, the communication may provide Internet connectivity, enabling a user to gain access to content on the Internet and to send and receive email or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the short range wireless communication sub-system 524. The USB interface 522 may be used to charge the device 401 and may also enable the device 401 to function as a peripheral device to exchange information with a personal computer or other computer system. The short range wireless communication sub-system 524 may include an infrared port, a Bluetooth interface, an IEEE 802.11 compliant wireless interface, or any other short range wireless communication sub-system, which may enable the device 401 to communicate wirelessly with other nearby mobile devices and/or wireless base stations. A long range wireless communication sub-system 550 may also be present and may be compliant with IEEE 802.16.

The input/output interface 518 may further connect the DSP 502 to the alert 526 that, when triggered, causes the device 401 to provide a notice to the user, for example, by ringing, playing a melody, or vibrating. The alert 526 may serve as a mechanism for alerting the user to any of various events such as an incoming call, a new text message, and an appointment reminder by silently vibrating, or by playing a specific pre-assigned melody for a particular caller.

The keypad 528 couples to the DSP 502 via the interface 518 to provide one mechanism for the user to make selections, enter information, and otherwise provide input to the device 401. The keypad 528 may be a full or reduced alphanumeric keyboard such as QWERTY, Dvorak, AZERTY and sequential types, or a traditional numeric keypad with alphabet letters associated with a telephone keypad. The input keys may include a trackwheel, an exit or escape key, a trackball, and other navigational or functional keys, which may be inwardly depressed to provide further input function. Another input mechanism may be the LCD 530, which may include touch screen capability and also display text and/or graphics to the user. The LCD controller 532 couples the DSP 502 to the LCD 530.

The CCD camera 534, if equipped, enables the device 401 to take digital pictures. The DSP 502 communicates with the CCD camera 534 via the camera controller 536. In another embodiment, a camera operating according to a technology other than Charge Coupled Device cameras may be employed. The GPS sensor 538 is coupled to the DSP 502 to decode global positioning system signals, thereby enabling the device 401 to determine its position. Various other peripherals may also be included to provide additional functions, e.g., radio and television reception.

FIG. 6 illustrates a software environment 602 that may be implemented by the DSP 502. Alternatively, the software environment 602 can be executed in an execution environment hosted by the central processing unit (CPU) 1310 on the device 401 or by a logical CPU with a combined DSP function. The DSP 502 executes operating system drivers 604 that provide a platform from which the rest of the software operates. The operating system drivers 604 provide drivers for the node hardware with standardized interfaces that are accessible to application software. The operating system drivers 604 include application management services (“AMS”) 606 that transfer control between applications running on the device 401, monitor applications, preempt applications, and perform other functions of an underlying operating system platform such as controlling, monitoring, and sometimes preempting or terminating logical processes, including execution threads.

Also shown in FIG. 6 are a web browser application 608, a media player application 610, and Java applets 612. The web browser application 608 configures the device 401 to operate as a web browser, allowing a user to enter information into forms and select links to retrieve and view web pages. The media player application 610 configures the device 401 to retrieve and play audio or audiovisual media. The Java applets 612 configure the device 401 to provide games, utilities, and other functionality. The AMS 606 may also host a Java Virtual Machine on which the Java applets 612 can execute. Other execution environments could also be hosted, such as a C runtime environment to support executable programs and applications written in the C programming language. A component 614 might provide functionality related to transport protocol performance.

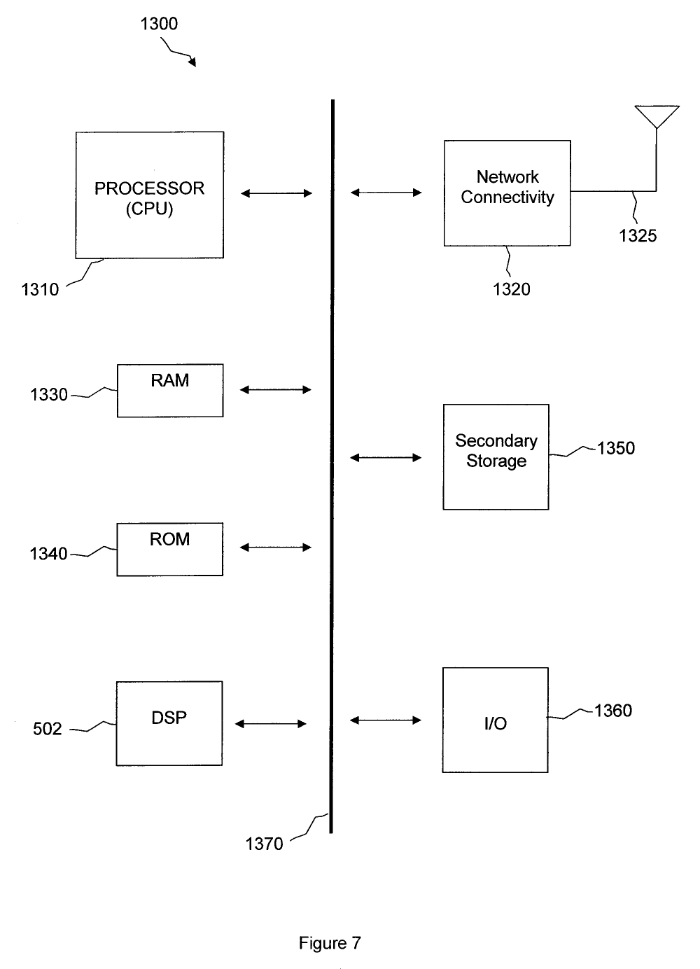

The device 401 and other components described above might include a processing component that is capable of executing instructions related to the actions described above. FIG. 7 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as the DSP 502 described above. Although the DSP 502 is shown as a separate component, the DSP 502 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver component 1325 may include data that has been processed by the processor 1310 or instructions that are to be executed by processor 1310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 1325 might be considered to be a component of the I/O devices 1360 instead of or in addition to being a component of the network connectivity devices 1320. Some or all of the I/O devices 1360 may be substantially similar to various components depicted in the previously described drawing of the device 401, such as the display 402 and the input 404.

In an embodiment, a device is disclosed. The device includes a storage device storing a data structure of features supported by the device. The data structure is created either dynamically or on command using an OpenMobileAlliance Device Management protocol.

In an alternative embodiment, a method of maintaining supported services is provided. The method includes providing an Open Mobile Alliance (OMA) Device Management (DM) tree having a management object including a data structure of supported services. The method further includes updating the data structure of supported services if modification of the OMA DM tree is detected.

OMA DM 1.2.1 is incorporated herein by reference for all purposes.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A device, comprising:
a storage device storing a data structure of features supported by the device, the data structure being created one of:
dynamically; and
on command using an OpenMobileAlliance (OMA) Device Management (DM) protocol.

2. The device of claim 1 wherein the data structure includes a root object and is configured in at least one of a list and a tree hierarchal structure.

3. The device of claim 2, wherein the data structure of features supported by the device is stored in a supported feature management object of an OMA DM management object.

4. The device of claim 3, wherein the device supported feature management object comprises a structure with one or more supported feature objects related to a plurality of supported features of the device.

5. The device of claim 4, wherein the supported features listed in the supported features managed object are an exact representation of the content of a DM tree managed object relating to the features supported by the device at a specific instance in time.

6. The device of claim 4, wherein the device supported feature management object is located within one of a device management tree, a link list, an array, and a file, and wherein the device supported feature management object includes a plurality management objects.

7. The device of claim 4, wherein each one of the plurality of supported features of the device supported feature management object are each associated with one of:
a current status management object associated with a management authority that modified the device supported feature management object and a date and time the management authority modified the device supported feature management object; and
a previous status management object associated with the same or different management authority that modified the device supported feature management object and a previous date and time the management authority modified the device supported feature management object.

8. The device of claim 1, wherein entries of the data structure of the supported features of the device comprise one of an extensible markup language (XML) entry, a universal resource locator (URL) entry, a directory path entry, and a graphical representation entry.

9. The device of claim 1, further comprising:
an agent that, when executed by a processor, monitors for changes to an Open Mobile Alliance (OMA) Device Management (DM) device management tree that includes a plurality of management objects and is operative to update a device supported feature management object with a supported feature of the device based on the state of the device management tree at a specific instance in time.

10. The device of claim 9, wherein the agent monitors device management transactions regarding the device management tree, and updates the device supported feature management object when the transactions involve a change to the device management tree related to the supported features of the device.

11. The device of claim 9, wherein the agent scans the entire device management tree to locate the supported feature of the device.

12. The device of claim 9, wherein the agent monitors for a change in the memory size of the device tree, and when a change occurs, the agent scans the device management tree and updates the device supported feature management object.

13. The device of claim 9, further comprising a listener configured for monitoring the device management tree and notifying the agent of a change in the device management tree if a block of data has changed.

14. The device of claim 9, wherein the agent determines for each one of the supported features of the device supported feature management object one of:
a current status management object associated with a management authority that modified the device supported feature management object and a date and time the management authority modified the device supported feature management object; and
a previous status management object associated with the same or different management authority that modified the device supported feature management object and a previous date and time the management authority modified the device supported feature management object.

15. The device of claim 9, wherein the agent is further operative to create the device supported feature management object.

16. A method of maintaining supported services, comprising:
providing an Open Mobile Alliance (OMA) Device Management (DM) tree having a management object including a data structure of supported services; and
updating the data structure of supported services if modification of the OMA DM tree is detected.

17. The method of claim 16, further comprising maintaining one or more status and date information related to modification of each of the supported services.

18. The method of claim 17, further comprising:
providing a data structure of device supported services in an Open Mobile Alliance (OMA) Device Management (DM) Management Object (MO); and
responsive to detecting modification of an OMA DM tree related to supported services, updating the data structure of device supported services.

19. The method of claim 18, wherein the supported services include device supported services and device features.

20. The method of claim 19, further comprising updating the data structure of supported services responsive to one or more of:
periodically scanning the OMA DM tree and detecting a change;
receiving notification of a change to the OMA DM tree; and
monitoring updates to the OMA DM tree.

21. A computer readable medium having recorded thereon instructions for executing the method of claim 16.
